(19) United States
(12) Patent Application Publication
(10) Pub. No.: US 2009/0148369 A1
(43) Pub. Date: Jun. 11, 2009

(54) OXYGEN STORAGE CAPACITY SUBSTANCE AND METHOD OF OXYGEN STORAGE CAPACITY IN THREE-WAY CATALYST FOR PURIFYING AUTOMOTIVE EXHAUST GAS

(76) Inventor: Toshiaki Mori, Aomori (JP)

Correspondence Address: Fay Sharpe LLP, 1228 Euclid Avenue, 5th Floor, The Halle Building, Cleveland, OH, 44115, US

(21) Appl. No.: 12/089,103

(22) PCT Filed: Sep. 20, 2006
(86) PCT No.: PCT/JP2006/318646

§ 371 Date: Jul. 14, 2008

(30) Foreign Application Priority Data
Sep. 20, 2005 (JP) 2005-272894

(51) Int. Cl. B01D 53/94; C01B 33/26

(52) U.S. Cl. 423/213.2; 423/328.1

(57) ABSTRACT

[PROBLEMS] To provide an oxygen storage substance which has higher oxygen storage capacity than conventional substances and is inexpensive. [MEANS FOR SOLVING PROBLEMS] The oxygen storage substance is a calcium aluminosilicate (mayenite), i.e., a substance of a crystal structure which is synthesized by hydrothermally treating a mixture of calcium oxide, alumina (sol), and amorphous silica, has a three-dimensional network composed of AlO₄ tetrahedrons and (Al,Si)O₄ tetrahedrons in which part of the aluminum atoms have been replaced with silicon atoms, with vertex oxygen atoms being shared, and has oxide ions (O₂⁻) occluded in microspaces in the structure. Part of the calcium atoms may be replaced with atoms of a transition metal, e.g., copper.

### TECHNICAL FIELD

The present invention relates to an oxygen storage capacity substance and a method of oxygen storage capacity in a three-way catalyst for purifying an automotive exhaust gas. More particularly, the present invention relates to an oxygen storage capacity substance, which has a higher oxygen storage capacity than conventional substances as represented by ceria and is inexpensive, and a method of oxygen storage capacity in a three-way catalyst for purifying an automotive exhaust gas.

### BACKGROUND ART

Three-way catalysts for purifying an automotive exhaust gas exhibit their highest purifying performance in a narrow range called window where a weight ratio of air and fuel (air/fuel ratio) is around 14.7. The window means an effective range of the air/fuel ratio in which all of three noxious components, CO, HC and NO can be harmlessly removed. If the narrow window range can be widened, an exhaust gas purification capacity of the three-way catalyst can be further improved.

FIG. 5 is a graph for illustrating relationship between the air/fuel ratio and conversion rates of the three noxious components such as CO.

Conventionally, ceria CeO₂, improved substances thereof such as ceria-zirconia, and ceria-based oxygen storage substances have been used in most cases for the purpose of widening the window range. Oxygen storage capacity substances mixed into the three-way catalysts introduce oxygen into their structure in an oxidative atmosphere and release oxygen in a reductive atmosphere. Therefore, when there is insufficient oxygen in an exhaust gas composition, oxygen is released from the oxygen storage substances, and when there is excessive oxygen, oxygen is absorbed by the oxygen storage capacity substances, so as to control the air/fuel ratio to be 14.7. The oxygen storage capacity substances allow for the three-way catalysts to exhibit an adequate exhaust gas purifying performance as described above by providing flexibility to the purifying performance of the respective noxious gases which show opposing conversion tendencies depending on the atmosphere. There also have been a few reports that propose the use of oxygen storage capacity substances other than the ceria-based substances (Non-Patent Documents as described below).

Non-Patent Document 1: Masakuni Ozawa, “Ceria and automotive catalyst”, Annual Report of the Ceramics Research Laboratory (2002), Vol. 2, 1-8
Non-Patent Document 2: Masahiro Sugiura, “Structure and oxygen storage capacity of ceria-zirconia for automotive catalysts”, Catalysts & Catalysis, Vol. 45, No. 4, 2003
Non-Patent Document 3: Masato Machida et al., “Large-capacity oxygen storage capacity by porous lanthanide Oxysulfate/oxysulfide systems)”, 95th CATSJ Meeting Abstructs, No. 2B12

### DISCLOSURE OF THE INVENTION

However, the conventional oxygen storage capacity substances for a three-way catalyst for purifying an automotive exhaust gas as represented by ceria do not always have a satisfactory oxygen storage capacity, and thus, the above window range cannot be sufficiently widened. It is therefore required worldwide to develop a substance having a higher oxygen storage capacity capable of achieving sophisticated control for maintaining the air/fuel ratio=14.7 and an excellent exhaust gas purifying performance thereby. Furthermore, none of the ceria-based substances or the substances which have been proposed as an alternative to the ceria-based substances is abundant in resources, and thus, it is difficult to lower the cost.

In light of the problems of the related arts as described above, an object of the present invention is to provide an oxygen storage capacity substance which has a higher oxygen storage capacity than the conventional substances and is inexpensive, and a method of oxygen storage capacity in a three-way catalyst for purifying an automotive exhaust gas.

There has been a proposal concerning an inorganic compound including active oxygen (Japanese Patent Laid-Open No. 2004-099430). The inorganic compound is a calcium aluminosilicate which is a novel active oxygen developing substance comprising an aluminosilicate obtained by synthesizing hydrogarnet as a precursor substance by a hydrothermal method and heating the hydrogarnet at 700° C. or higher. The chemical composition thereof is expressed by Ca₁₂(Al_{14-X}Si_{X})O_{33+0.5X}, and the value of X in the chemical composition is in the range of 0<x≦4. The novel active oxygen developing substance and a molded article thereof are considered to be useful as a constituent of members such as an oxidation catalyst, a solid electrolyte, and an oxygen occlusion carrier.

FIG. 6 is a schematic view for illustrating a crystal structure thereof.

The inventor of the present application has found that, when the above substance is used as an oxygen storage capacity substance in a three-way catalyst for purifying an automotive exhaust gas, there can be obtained a much better effect than that by the conventional substances such as ceria in a much inexpensive way. The inventor has also found that a higher oxygen storage capacity can be exhibited by substituting a part of Ca in a structure of the above substance with a transition metal, so as to achieve the present invention. The invention claimed in the present application, or at least disclosed herein, as means for solving the above problem is as described below.

(1) An oxygen storage capacity substance for use in a three-way catalyst for purifying an automotive exhaust gas, comprising a calcium aluminosilicate in which an oxide anion, O₂⁻ and O₂²⁻, that is lost in a reductive atmosphere and is regenerated in an oxidative atmosphere is occluded in its structure, or a transition metal substitute thereof.

(2) The oxygen storage capacity substance according to (1), characterized in that the oxygen storage capacity substance is a transition metal-substituted calcium aluminosilicate.

(3) The oxygen storage capacity substance according to (2), characterized in that the transition metal is at least one of copper Cu, chromium Cr, cobalt Co, nickel Ni, or iron Fe.

(4) The oxygen storage capacity substance according to (3), characterized in that the transition metal is copper Cu, with which calcium Ca in the structure is substituted, with a Cu/Ca molar ratio being in a range of 0.01 or more to 0.1 or less.

(5) A method of oxygen storage capacity in a three-way catalyst for purifying an automotive exhaust gas, characterized in that a transition metal-substituted calcium aluminosilicate in which an oxide anion, O₂⁻ and O₂²⁻, is occluded in its structure is used in a three-way catalyst for purifying an automotive exhaust gas.

(6) Use of a transition metal-substituted calcium aluminosilicate in which an oxide anion, O₂⁻ and O₂²⁻, is occluded in its structure, as an oxygen storage capacity substance in a three-way catalyst for purifying an automotive exhaust gas.

As described above, the method of synthesizing the calcium aluminosilicate for use in the present invention has been already disclosed. Briefly, a substance of a crystal structure is obtained which is synthesized by hydrothermally treating a mixture of calcium oxide, alumina (sol), and amorphous silica, has a three-dimensional network composed of AlO₄ tetrahedrons and (Al, Si)O₄ tetrahedrons in which a part of Al in the tetrahedrons has been substituted with Si, with apical oxygen atoms being shared, and has oxide anion, O₂⁻ and O₂²⁻, occluded in microspaces in the structure as shown in FIG. 6. However, there has been no document which clearly describes that the above substance can be sufficiently applied as an oxygen storage capacity substance, especially as an oxygen storage capacity substance for a three-way catalyst for purifying an automotive exhaust gas.

Since the oxide anion, O₂⁻ and O₂²⁻, occluded in the crystal structure of the present substance become H₂O and are lost in a reductive atmosphere, and are quickly regenerated in an oxidative atmosphere, the present substance can function as an oxygen storage capacity substance. The use of present substance is totally different from that of the conventional oxygen storage capacity substances such as ceria, and its constituent elements are Ca, Al, and Si, which are abundant in resources, so as to provide the present substance at a much lower price.

Furthermore, in the present invention, the transition metal-substituted calcium aluminosilicate obtained by substituting a part of calcium ions Ca²⁺ in the crystal structure of the calcium aluminosilicate with transition metal ions such as copper ions Cu²⁺ is disclosed as an oxygen storage capacity substance having a higher capacity. The transition metal-substituted calcium aluminosilicate is synthesized by hydrothermally treating a mixture of calcium oxide, alumina, amorphous silica, and transition metal oxide which is equally abundant in resources. In the transition metal-substituted calcium aluminosilicate of the present invention, oxygen is more remarkably released and regenerated than the non-substituted substance, and its oxygen storage capacity is dramatically improved.

The oxygen storage capacity substances and the method of oxygen capacity storage in a three-way catalyst for purifying an automotive exhaust gas according to the present invention are constituted as described above. Because of the feature, an extremely high oxygen storage capacity, surpassing those of the conventional substances such as ceria or the like, can be obtained at a much lower cost. The substances according to the present invention can be produced using only the elements having abundant resources, unlike ceria or the like, and therefore, the present invention has an inestimable effect.

### BRIEF DESCRIPTION OF THE DRAWINGS

FIG. 1A is a schematic view for illustrating a crystal structure of a calcium aluminosilicate according to the present invention in a reductive atmosphere;

FIG. 1B is a schematic view for illustrating a crystal structure of a calcium aluminosilicate according to the present invention in an oxidative atmosphere;

FIG. 2 is an explanatory view for illustrating a configuration of a pulse reaction apparatus;

FIG. 3 is a graph for illustrating a measurement result of O₂ absorption amounts with respect to mayenite (non-substituted) and mayenite substituted with Cu;

FIG. 4 is a graph for illustrating integrated values of O₂ introduction amounts per an injection time in the measurement test of the O₂ absorption amounts shown in FIG. 3;

FIG. 5 is a graph for illustrating relationship between an air/fuel ratio and conversion rates of three noxious components such as CO; and

FIG. 6 is a schematic view for illustrating a crystal structure of a calcium aluminosilicate which is an active oxygen developing substance.

1: Catalyst layer
2: Small reaction tube
3: Gas injection portion
4: Electric furnace
5: Separation column
6: Detector
7: He carrier gas inlet
8: Pressure regulating valve
9: Outlet

### BEST MODE FOR CARRYING OUT THE INVENTION

The present invention will be described below in more detail with reference to the drawings.

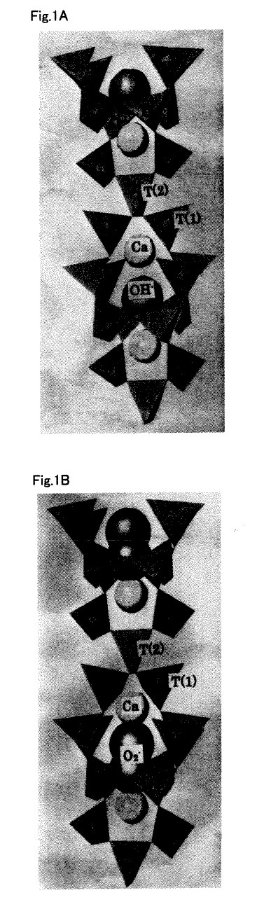

FIGS. 1A and 1B are schematic views for illustrating a crystal structure of a calcium aluminosilicate according to the present invention. FIG. 1A shows a structure in a reductive atmosphere and FIG. 1B shows a structure in an oxidative atmosphere. As shown in the drawings, the present substance is mayenite which is a substance of a crystal structure having a three-dimensional network composed of AlO₄ tetrahedrons (T(1) in the drawings) and (Al, Si)O₄ tetrahedrons (T(2) in the drawings) in which a part of Al in the tetrahedrons has been substituted with Si, with apical oxygen atoms being shared, and having oxide anions, O₂⁻ and O₂²⁻, occluded in microspaces in the structure. Since the oxide anions, O₂⁻ and O₂²⁻, occluded in the crystal structure of the present substance become H₂O and are lost in a reductive atmosphere, and are quickly regenerated in an oxidative atmosphere, the present substance can function as an oxygen storage capacity substance.

The compositional formula of the calcium aluminosilicate may be expressed as below.

Ca₁₂(Al_{14-X}Si_{X})O_{33+0.5X}

The value of X is in the range of 0<x≦4.

The compositional formula may be also expressed as below.

Ca₁₂Al₁₀Si₄O₃₂X₃, X=2OH⁻,O₂⁻

When the substance of the present invention is mixed into a three-way catalyst, the oxide anions, O₂⁻ and O₂²⁻, occluded in the structure become H₂O and are lost in a reductive atmosphere, and oxygen is introduced into the structure to regenerate the oxide anions, O₂⁻ and O₂²⁻, in an oxidative atmosphere. Accordingly, when there is insufficient oxygen in an exhaust gas composition, oxygen is released from the present substance, and when there is excessive oxygen, the present substance absorbs oxygen. An air/fuel ratio is thereby controlled to be 14.7, to make the three-way catalyst exhibit an adequate exhaust gas purifying performance. As described below in examples, the oxygen storage capacity is extremely high, surpassing those of the conventional substances.

The calcium aluminosilicate itself has the high oxygen storage capacity as described above. However, a transition metal-substituted calcium aluminosilicate of the present invention obtained by substituting a part of calcium ions Ca²⁺ in its crystal structure with transition metal ions such as copper ions Cu²⁺ has a higher oxygen storage capacity as described below in examples.

The transition metal-substituted calcium aluminosilicate is synthesized by hydrothermally treating a mixture of calcium oxide, alumina, amorphous silica, and transition metal oxide, and as shown in FIGS. 1A and 1B, has the crystal structure in which a three-dimensional network composed of AlO₄ tetrahedrons (T(1) in the drawings) and (Al, Si)O₄ tetrahedrons (T(2) in the drawings) in which a part of Al in the tetrahedrons has been substituted with Si, with apical oxygen atoms being shared, is formed, oxide anions, O₂⁻ and O₂²⁻, are occluded in microspaces in the structure, and a part of Ca²⁺ is substituted with transition metal ions (not shown).

The transition metal may be any element such as chromium Cr, cobalt Co, nickel Ni, or iron Fe as well as copper Cu.

As to a ratio of substituting calcium Ca in the structure of the above substance with the transition metal such as Cu, a Cu/Ca molar ratio, in particular, may be in the range of 0.01 or more to 0.1 or less. At least in the range, adequate oxygen storage capacity effects can be obtained.

### EXAMPLES

Although examples of the present invention will be described below, the present invention is not limited to such examples.

### (1) Example 1

### Production of a Calcium Aluminosilicate (Mayenite)

A calcium aluminosilicate was synthesized by hydrothermally treating a mixture of calcium oxide, alumina (sol), and amorphous silica by the method disclosed in the above document (Japanese Patent Laid-Open No. 2004-099430). The synthesized substance was evaluated in accordance with the method of the above document as well.

### (2) Example 2

### Production of a Cu-Substitute of a Calcium Aluminosilicate (Mayenite)

A Cu-substitute of a calcium aluminosilicate was synthesized by hydrothermally treating a mixture of calcium oxide, alumina (sol), amorphous silica, and copper oxide as in (1). The added metal species was a cupric nitrate and such an amount of the cupric nitrate that the molar ratio with respect to the calcium oxide became Cu/Ca=0.05 was added.

### (3) Evaluation of Oxygen Storage Capacity

### A Method of Measuring an Amount of O₂ Absorption (Introduction Amount)

By using a pulse reaction apparatus with a small reaction tube incorporated between a sample injection portion and a separation column of a gas chromatography apparatus, the amount of O₂ absorption of the substance of each of the above examples was measured.

FIG. 2 is an explanatory view for illustrating a configuration of the pulse reaction apparatus. The amount of O₂ absorption was measured by the following procedure. The mayenite sample (sample in powder, pellet, or granular form) of each of the examples was disposed at a catalyst layer 1 in a small reaction tube 2, and 3 ml of H₂ was injected first by using an injector from a gas injection portion 3, to remove O₂⁻ and O₂²⁻ in the sample. Next, 0.1 ml of O₂ was injected likewise for a few times. Since O₂ was introduced into the sample substance at first, O₂ was not detected. When O₂ was sufficiently introduced into the sample substance and the sample substance reached a saturated state, the injected O₂ passed through the reaction tube 2 without being introduced into the sample substance, flew out to the separation column 5, and was detected by a detector 6. By subtracting the amount of O₂ in the case where the amount of O₂ is decreased by being introduced, from the amount of O₂ in the case where O₂ flows out without being introduced, the amount of O₂ introduced into the sample substance of each of the examples can be calculated. Briefly, the amount of introduced O₂ can be obtained by successively injecting 0.1 ml of O₂ into the oxide anion-lost mayenite in which O₂ has been removed by injecting H₂.

### (4) Measurement Result of the Amount of O₂ Absorption (Introduction Amount) in Each of the Examples

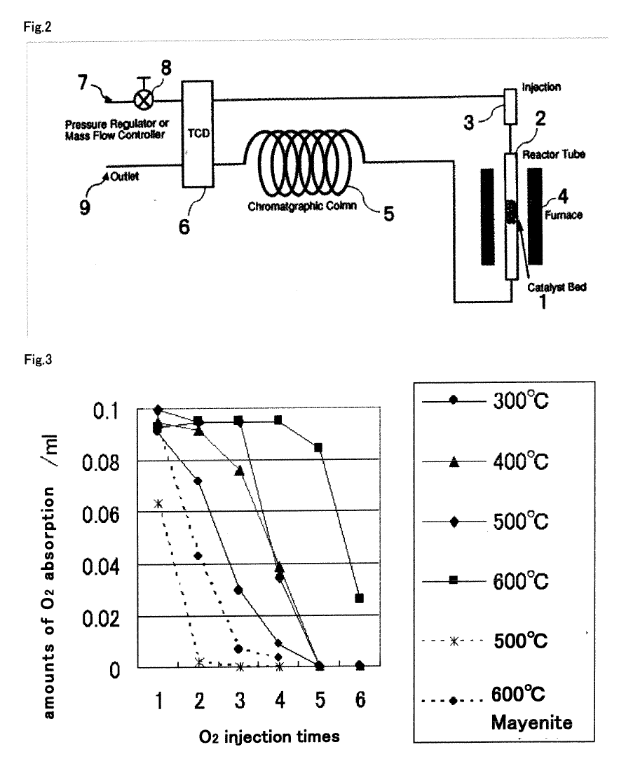

FIG. 3 is a graph for illustrating a measurement result of the amounts of O₂ absorption with respect to the mayenite (non-substituted) and the Cu-substituted mayenite by using the above method. The lateral axis represents the number of O₂ injection times successively performed. The vertical axis represents the amount of O₂ introduction (ml) per 50 mg of the samples such as the mayenite. The graph shows the result of measuring the amounts of O₂ absorption under a plurality of temperature conditions with respect to each of the examples.

As shown in the drawing, the non-substituted mayenite scarcely introduced O₂ at the second or third injection. That is to say, the O₂ introduction reached the limit at the first injection (0.1 ml) or the first and the second injections (0.2 ml). Meanwhile, it took more times for the Cu-substituted mayenite to reach the O₂ introduction limit than the non-substituted mayenite, and it was shown that the transition metal substitute of the mayenite has an excellent O₂ introduction capacity, namely, an excellent oxygen storage capacity in comparison with the non-substituted mayenite. Especially under the condition of 600° C., almost all the amount of O₂ could be absorbed into the structure even when O₂ was injected for five times (0.5 ml).

### (5) Total Amount of Oxygen Introduction

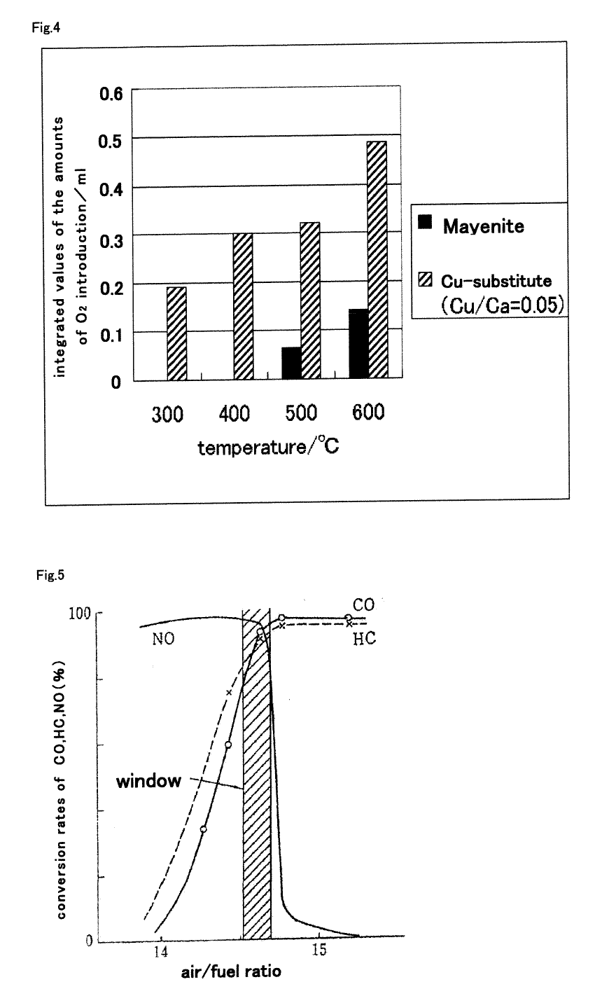

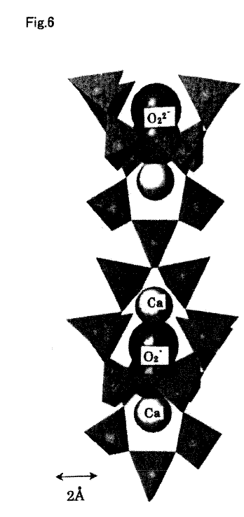

FIG. 4 is a graph for illustrating integrated values of the amounts of O₂ introduction per an injection time in the measurement test of the amounts of O₂ absorption shown in FIG. 3. The lateral axis represents the temperature conditions. As shown in the drawing, the total amount of oxygen introduction of the Cu-substitute was larger in comparison with the non-substituted mayenite under any temperature condition. Especially under the conditions of 500° C. and 600° C. the Cu-substitute had the introduction amounts as much as about four times those of the non-substituted mayenite. The total amounts of oxygen introduction under the condition of 600° C. were 118 μmol/g with respect to the non-substituted mayenite and 406 μmol/g with respect to the Cu-substituted mayenite.

### (6) Comparison with Conventional Oxygen Storage Substances

The amounts of oxygen introduction were measured with respect to the conventional oxygen storage capacity substances and the substances of the present invention by using the method of (3). The used substance amount was 50 mg.

While the oxygen storage capacity of ceria CeO₂ was 7 μmol/g and the oxygen storage capacity of 10% ceria-zirconia Ce/ZrO₂ was 40 μmol/g, the oxygen storage capacity of the non-substituted mayenite of the present invention was about 117 μmol/g and the oxygen storage capacity of the Cu-substituted mayenite of the present invention was about 400 μmol/g. It was shown that the substances of the present invention have an extremely high oxygen storage capacity which is ten times or more those of the related arts.

### (7) Example 3 A Cu-Substitute 2 of a Calcium Aluminosilicate (Mayenite)

Cu-substituted mayenite was produced by the same conditions as in the example 2 except that the Cu/Ca ratio=0.025. The total amount of oxygen introduction under the condition of 500° C. was about 0.3 ml. The Cu-substituted mayenite in this example exhibited the oxygen storage capacity as much as five times that of the non-substituted mayenite although the oxygen storage capacity did not reach that of the example 2 with the Cu/Ca ratio=0.05.

### (8) Example 4 A Cr-Substitute of a Calcium Aluminosilicate (Mayenite)

Chromium Cr was used as the substitute metal, and Cr-substituted mayenite was produced by the same conditions as in the example 2 except that a Cr/Ca ratio=0.05. The total amount of oxygen introduction under the condition of 600° C. was about 0.2 ml, and the Cr-substituted mayenite in this example exhibited the higher oxygen storage capacity than that of the non-substituted mayenite which was about 0.14 ml although the oxygen storage capacity did not reach that of the Cu-substituted mayenite in the examples 2 and 3.

### INDUSTRIAL APPLICABILITY

The constituent elements of the oxygen storage capacity substances according to the present invention are Ca, Al, Si, and the transition metals, which are rich in resources, and their prices are much cheaper than the conventional substances as represented by ceria. Nevertheless, the oxygen storage capacity substances according to the present invention show an excellent oxygen storage capacity, surpassing those of the conventional substances. Especially, the technical field requiring the oxygen storage capacity substances includes the automotive industry, whose market size is huge. Therefore, the present invention has a great deal of potential and has an inestimable impact in this field.

1. An oxygen storage capacity substance for use in a three-way catalyst for purifying an automotive exhaust gas, comprising a calcium aluminosilicate in which an oxide anion, O₂⁻ and O₂²⁻, that is lost in a reductive atmosphere and is regenerated in an oxidative atmosphere is occluded in its structure, or a transition metal substitute thereof.

2. The oxygen storage substance according to claim 1, characterized in that the oxygen storage capacity substance is a transition metal-substituted calcium aluminosilicate.

3. The oxygen storage capacity substance according to claim 2, characterized in that the transition metal is at least one of copper Cu, chromium Cr, cobalt Co, nickel Ni, or iron Fe.

4. The oxygen storage capacity substance according to claim 3, characterized in that the transition metal is copper Cu, with which calcium Ca in the structure is substituted, with a Cu/Ca molar ratio being in a range of 0.01 or more to 0.1 or less.

5. A method of oxygen storage capacity in a three-way catalyst for purifying an automotive exhaust gas, characterized in that a transition metal-substituted calcium aluminosilicate in which oxide anions, O₂⁻ and O₂²⁻, are occluded in its structure is used in a three-way catalyst for purifying an automotive exhaust gas.

6. Use of a transition metal-substituted calcium aluminosilicate in which oxide anion, O₂⁻ and O₂²⁻, are occluded in its structure, as an oxygen storage capacity substance in a three-way catalyst for purifying an automotive exhaust gas.
